(19) United States
(12) Patent Application Publication
(10) Pub. No.: US 2025/0259546 A1
(43) Pub. Date: Aug. 14, 2025

(54) PILOT ASSISTANCE SYSTEM

(71) Applicant: HONDA MOTOR CO., LTD., Tokyo (JP)

(72) Inventors: Keiichi Arai, Wako-shi (JP); Tsuyoshi Harada, Wako-shi (JP); Hiroyuki Yamamoto, Wako-shi (JP); Mio Oshima, Wako-shi (JP)

(21) Appl. No.: 18/441,062

(22) Filed: Feb. 14, 2024

(51) Int. Cl. G08G 3/00; B63B 49/00; B63B 79/10

(52) U.S. Cl. CPC G08G 3/00; B63B 79/10; B63B 49/00

(57) ABSTRACT

An operation support system according to an embodiment includes: a display mounted in a watercraft; and a display control unit causing the display to display objects in which a rudder angle representing a rudder angle of a propeller of the watercraft and a wind direction representing a wind direction in the vicinity of the watercraft are disposed on concentric circles.

### BACKGROUND

### Field of the Invention

The present invention relates to an operation support system.

### Description of Related Art

In recent years, initiatives to provide access to sustainable transportation systems also for vulnerable traffic participants such as entry-level users are becoming more active (for example, see United States Patent Application Publication No. 2020/0369351).

### SUMMARY

Also among transportation systems, in the operation of watercrafts such as ships, entry-level users may feel anxiety. Particularly, entry-level users frequently operate small-sized ships. Since a small-sized ship has a lower weight than a large ship, it is easily influenced by wind, and, depending on a wind direction, may not advance in a direction represented by a rudder angle. The present invention is in view of such situations, and one objective thereof is to provide an operation support system allowing anyone to easily operate a watercraft by performing visual support that can be easily and intuitively understood by a user.

An operation support system according to the present invention employs the following configurations.
(1) A first example of the present invention is an operation support system comprising: a display mounted in a watercraft; and a display control unit causing the display to display objects in which a rudder angle representing a rudder angle of a propeller of the watercraft and a wind direction representing a wind direction in the vicinity of the watercraft are disposed on concentric circles.
(2) According to a second example of the present invention, in the operation support system of the first example, the display control unit causes the display to display the object in which the rudder angle is disposed on any one of the inside and the outside of the concentric circle, and the wind direction is disposed on the other side of the inside and the outside of the concentric circles.
(3) According to a third example of the present invention, in the operation support system of the second example, the display control unit causes the display to display the object in which the rudder angle is disposed on the inside of the concentric circle, and the wind direction is disposed on the outside of the concentric circle.
(4) According to a fourth example of the present invention, in the operation support system of the first example, a forward rudder angle representing the rudder angle at the time of the watercraft going forward and a backward rudder angle representing the rudder angle at the time of the watercraft going backward are included in the rudder angle, and wherein, in a case in which a circumference of the concentric circle is divided into two arcs, the display control unit causes the display to display the object in which the forward rudder angle is disposed in one arc division, and the backward rudder angle is disposed in the other arc division.
(5) According to a fifth example of the present invention, in the operation support system of the fourth example, the display control unit displays any one of the forward rudder angle and the backward rudder angle to be emphasized in accordance with a shift position of the watercraft.
(6) According to a sixth example of the present invention, in the operation support system of the first example, the display control unit further displays an azimuth on the concentric circle of the object.
(7) According to a seventh example of the present invention, in the operation support system of the first example, the display control unit further displays sailing information that is other information relating to sailing of the watercraft in the display. According to one of the examples described above, visual support that can be easily and intuitively understood by a user can be performed, and as a result, anyone can easily operate a watercraft.

### BRIEF DESCRIPTION OF THE DRAWINGS

FIG. 1 is a diagram illustrating a whole watercraft according to an embodiment.

FIG. 2 is a diagram illustrating one example of installation positions of cameras according to an embodiment.

FIG. 3 is a diagram illustrating one example of an outboard motor steering device according to an embodiment.

FIG. 4 is a configuration diagram of a processing device according to an embodiment.

FIG. 5 is a flowchart illustrating a flow of a series of processes of a processing device according to an embodiment.

FIG. 6 is an example illustrating one example of installation points of calibration boards.

FIG. 7 is a diagram illustrating one example of a screen of a display according to an embodiment.

FIG. 8 is a diagram illustrating one example of a ship object and a virtual line object.

FIG. 9 is a diagram illustrating another example of a ship object and a virtual line object.

FIG. 10 is a diagram illustrating another example of a ship object and a virtual line object.

FIG. 11 is a diagram illustrating another example of a ship object and a virtual line object.

FIG. 12 is a diagram illustrating one example of a rudder angle object.

FIG. 13 is a diagram illustrating one example of an azimuth object and a wind direction/wind speed object.

FIG. 14 is a diagram illustrating one example of a distance marker.

FIG. 15 is a diagram illustrating one example of a screen of a second display according to an embodiment.

FIG. 16 is a diagram illustrating one example of an image object at the time of having a tail wind.

FIG. 17 is a diagram illustrating one example of an image object at the time of being against the wind.

FIG. 18 is a diagram illustrating another example of a screen of a second display according to an embodiment.

### DESCRIPTION OF EMBODIMENTS

Hereinafter, an operation support system according an embodiment of the present invention will be described with reference to the drawings.

### Configuration of Watercraft

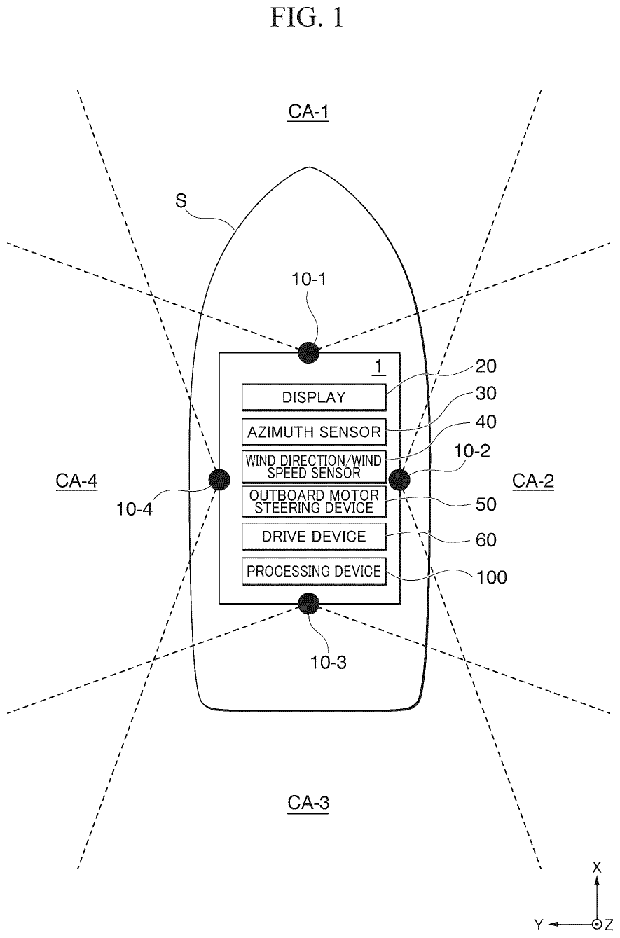

FIG. 1 is a diagram illustrating a whole watercraft S according to an embodiment. Although the watercraft S is, typically, a ship such as a pontoon ship, an offshore ship, a V-hull boat ship, or a run-about ship, it is not limited thereto and may be any other mobile body such as a jet ski.

An operation support system 1 is mounted in the watercraft S. The operation support system 1, for example, includes a plurality of cameras 10, a display 20, an azimuth sensor 30, a wind direction/wind speed sensor 40, an outboard motor steering device 50, a drive device 60, and a processing device 100.

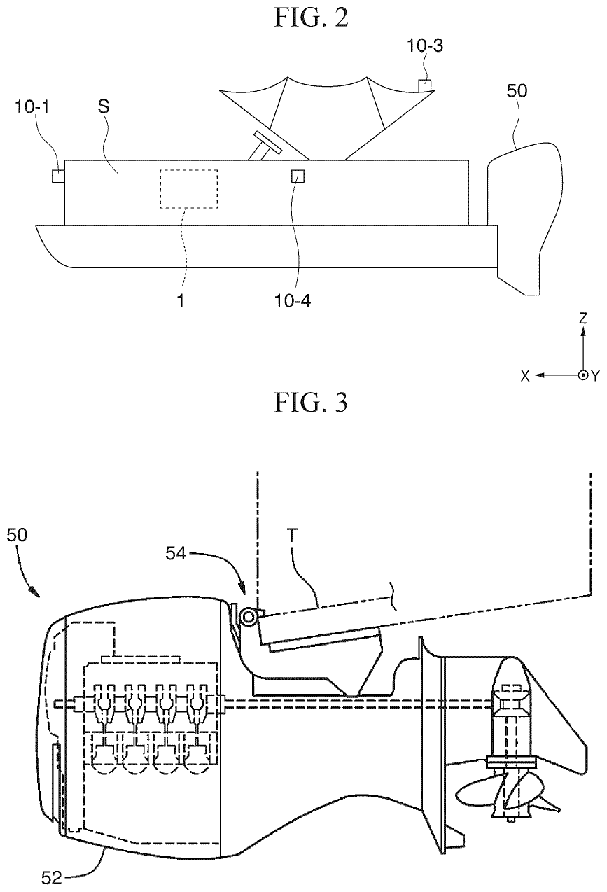

FIG. 2 is a diagram illustrating one example of installation positions of cameras 10 according to an embodiment. As illustrated in the drawing, the cameras 10, for example, may be configured such that one camera is installed on each of a front side, a rear side, a right side, and a left side of a body of a watercraft S. For example, the cameras 10 adjacent to each other such as a front-side camera 10-1 and a right-side camera 10-2, and the right-side camera 10-2 and a rear-side camera 10-3 are arranged such that parts of imaging areas overlap each other. For example, the front-side camera 10-1 may be disposed at a tip end of the watercraft S, the right-side camera 10-2 and the left-side camera 10-4 may be disposed on outer walls of lateral sides of an operation room, and the rear-side camera 10-3 may be disposed in a roof rear part of the operation room. For example, a plurality of cameras 10 may be installed at each place. The camera 10 can image the vicinity of the watercraft S and can image a place at an arbitrary distance from the watercraft S to a place at further another arbitrary distance. The camera 10, for example, can image a place at the distance of 30 [cm] from the watercraft S to a place at the distance of 30 [m]. FIGS. 1 and 2 illustrate four cameras 10-1 to 10-4, and imaging ranges CA-1 to CA-4 of imaging units are illustrated. Hereinafter, an image of the vicinity of the watercraft S imaged by each camera 10 will be referred to as “oblique view” in description. In addition, various kinds of image processing (contrast correction, brightness correction, noise removal, edge enhancement, enlargement, reduction, trimming, and the like) may be performed on the oblique view.

The display 20 displays an image generated by the processing device 100, a graphical user interface (GUI) for accepting various input operations from a user, and the like. For example, the display 20 is a liquid crystal display (LCD), an organic electroluminescence (EL) display, or the like. In a case in which the display 20 is caused to function as a GUI, the display 20 may be a touch panel.

The display 20, for example, is installed in an operation room. In the operation room, a single display 20 may be installed, or a plurality of displays 20 may be installed. In this embodiment, a plurality of displays 20 are assumed to be installed in an operation room, one display 20 will be referred to as a first display 20-1, and the other display 20 will be referred to as a second display 20-2 in description.

A screen of the display 20 may be either flat or curved. Although the contour of the screen of display 20 is typically rectangular, it is not limited to this and may also be in other shapes such as triangular, circular, or elliptical.

The azimuth sensor 30, for example, includes a gyro sensor, a magnetic sensor, and the like. The azimuth sensor 30 measures an azimuth.

The wind direction/wind speed sensor 40 measures a wind direction and a wind speed of the surroundings of the watercraft S.

The outboard motor steering device 50, for example, is attached to a rear end of the watercraft S. The outboard motor steering device 50 generates a propulsion force for the watercraft S and adjusts the angle of the rudder (that is, a rudder angle) of the watercraft S.

FIG. 3 is a diagram illustrating one example of the outboard motor steering device 50 according to an embodiment. For example, the outboard motor steering device 50 is housed in a housing 52 and is attached to a transom T of the watercraft S through a clamping mechanism 54. As the clamping mechanism 54, a known mechanism may be employed, and it causes the outboard motor steering device 50 to tilt in a horizontal direction or tilt in a vertical direction. The outboard motor steering device 50 rotates with respect to the watercraft S using a steering motor. An amount of steering is detected as an amount of stroke of the steering motor and may be transmitted to the processing device 100 through controller area network (CAN) communication. The amount of steering may be detected as an amount of operation of a steering wheel. The amount of steering of the outboard motor steering device 50 may be displayed on the display 20 by the processing device 100. A displacement of the amount of steering may be linearly displayed.

The description of FIG. 2 will be continued. The drive device 60 drives the outboard motor steering device 50 using fuel such as gasoline, electric power charged in a battery, or the like.

The processing device 100, for example, generates an image for supporting an operation of an operator (occupant) of the watercraft S using an image of the vicinity of the watercraft S, that is, an oblique view imaged by each camera 10 and displays the generated image in any one of the first display 20-1 and the second display 20-2 or in both the first display 20-1 and the second display 20-2.

### Configuration of Processing Device

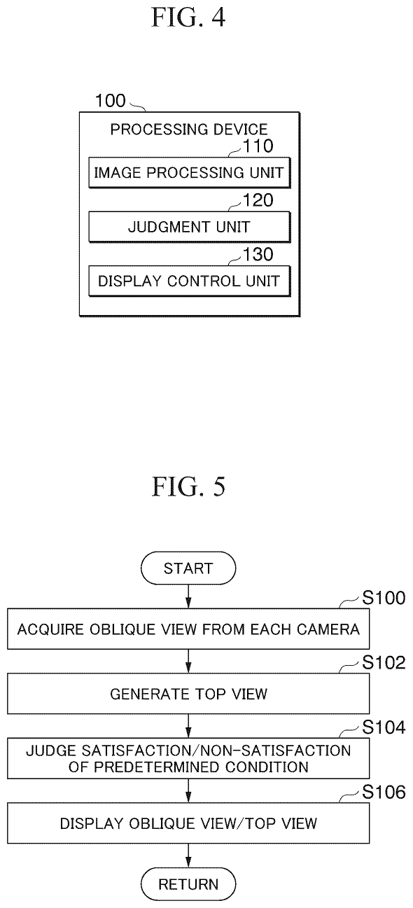

FIG. 4 is a configuration diagram of the processing device 100 according to the embodiment. The processing device 100, for example, includes an image processing unit 110, a judgment unit (the determination unit) 120, and a display control unit 130. Such constituent elements, for example, are realized by a hardware processor such as a central processing unit (CPU) executing a program (software). Some or all of such constituent elements may be realized by hardware (a circuit unit; including circuitry) such as a large scale integration (LSI), an application specific integrated circuit (ASIC), a field-programmable gate array (FPGA), a graphics processing unit (GPU), or a system on chip (SOC) or may be realized by software and hardware in cooperation. The program may be stored in a storage device (a storage device including a non-transitory storage medium) such as a hard disk drive (HDD) or a flash memory in advance or may be stored in a loadable/unloadable storage medium (a non-transitory storage medium) such as a DVD or a CD-ROM and be installed by mounting the storage medium in a drive device.

### Process Flow of Processing Device

Hereinafter, the process of each constituent element of the processing device 100 will be described on the basis of a flowchart. FIG. 5 is a flowchart illustrating a flow of a series of processes of the processing device 100 according to the embodiment. The process of this flowchart may be repeatedly performed with a predetermined period. First, the image processing unit 110 acquires an oblique view from each of a plurality of cameras 10 (Step S100). In other words, the image processing unit 110 acquires an oblique view of the front side of the watercraft S from the front-side camera 10-1, acquires an oblique view of the right side of the watercraft S from the right-side camera 10-2, acquires an oblique view of the left side of the watercraft S from the left-side camera 10-4, and acquires an oblique view of the rear side of the watercraft S from the rear-side camera 10-3.

Next, by performing a predetermined process for the oblique view of each of the plurality of cameras 10, the image processing unit 110 generates an image acquired by looking down the watercraft S from the top (hereinafter, referred to as a top view) from a plurality of oblique views.

Here, calibration used for generating a top view from oblique views will be described. A manager of the watercraft S performs calibration in advance on land or the like. The manager installs calibration boards at a height at which a watercraft S actually drafts water and measures coordinates of installation points of the calibration boards.

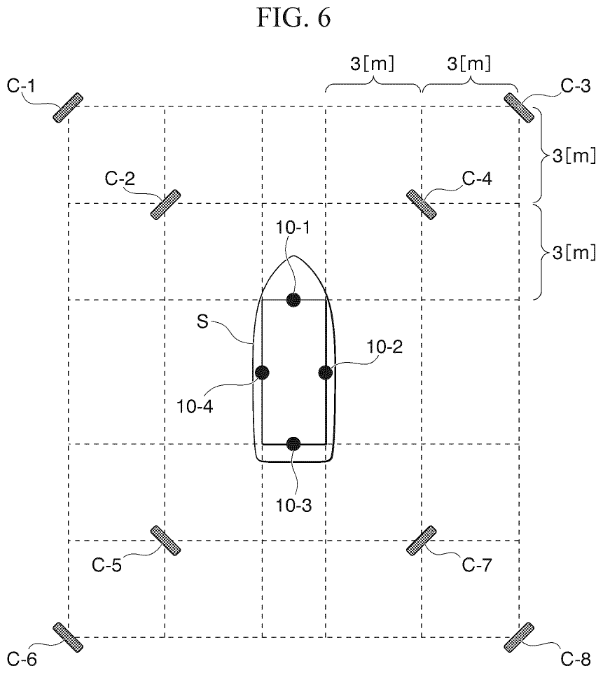

FIG. 6 is an example illustrating one example of installation points of calibration boards. The coordinates, for example, are partitioned into sections of 3 [m]×3 [m] having the watercraft S as its center. The watercraft 5, for example, includes four cameras 10. The installation points C-1 to C-8 of the calibration boards are illustrated. A manager photographs images of the vicinity of the watercraft S using the four cameras 10. The photographed images are stored in an electronic control unit (ECU) (not illustrated) and are conveyed to another device using a universal serial bus (USB) memory or the like. The other device is a computer device that can perform calibration. A manager measures coordinates of the calibration boards in an image.

The manager calculates three-dimensional coordinates using the principle of epipolar matching. In the epipolar matching, the coordinates of calibration boards in a real space and the coordinates of the calibration boards in an image are set as input information, a virtual perpendicular line is drawn in a three-dimensional space from coordinates of a plane of the camera 10, and an intersection between the virtual perpendicular line and a virtual perpendicular line from the coordinates of the plane of another camera 10 is set as three-dimensional coordinates. The manager installs information of the three-dimensional coordinates in the image processing unit 110. In accordance with this, the image processing unit 110 can convert images captured by the cameras 10 into a top view.

The description of the flowchart will be continued. Next, the judgment unit 120 judges (the determination unit 120 determines) whether or not a positional relation between an obstacle present in the vicinity of the watercraft S and the watercraft S satisfies a predetermined condition using the top view generated by the image processing unit 110 (Step S104).

The obstacle, for example, is another watercraft, a dock, a trailer, a person, a floating object or the like.

First, for example, by inputting oblique views or a top view to a first machine learning model that has been generated in advance using a technique such as machine learning or the like and has learned to output presence and a type of an obstacle when an image is input thereto, the judgment unit 120 detects obstacles in the vicinity of the watercraft S.

The first machine learning model is a machine learning model that has been trained on the basis of a training data set associated with presence and a type of an obstacle as a label (also referred to as a target) for images such as oblique views or a top view. The first machine learning model trained in this way outputs presence and a type of an obstacle in accordance with input of images such as oblique views or a top view.

For example, the first machine learning model is a model to which an algorithm of machine learning such as supervised learning or a regression analysis is applied. The first machine learning model, for example, may be implemented using a deep neural network or may be mounted using polynomial regression, multiple regression, support vector regression, random forest regression, or the like.

Furthermore, by inputting a top view generated by the image processing unit 110 to a second machine learning model that has been trained in advance to output a position (coordinates) of an obstacle when a top view is input, the judgment unit 120 identifies a position of an obstacle present in the vicinity of the watercraft S.

The second machine learning model is a machine learning model that has been trained on the basis of a training data set associated with a position (coordinates) of an obstacle as a label (also referred to as a target) for a top view. The second machine learning model trained in this way outputs a position (coordinates) of an obstacle in accordance with input of a top view. The position (coordinates) of the obstacle, for example, represents using a position of a point on a plane that is partitioned as one grid of 10 [cm].

For example, the second machine learning model, similar to the first machine learning model, may be implemented using a deep neural network or may be mounted using polynomial regression, multiple regression, support vector regression, random forest regression, or the like.

The judgment unit 120 judges whether or not the positional relation between an obstacle of which the position has been identified using the second machine learning model and the watercraft S satisfies a predetermined condition.

In the predetermined condition, for example, (i) a relative distance between the watercraft S and an obstacle being a predetermined distance or less, (ii) a reference distance (for example, a speed x several seconds) that is a distance based on a speed of the watercraft S being a predetermined distance or less, (iii) a collision prediction time of the watercraft S and an obstacle (a value acquired by dividing the relative distance between the watercraft S and the obstacle by the relative speed between the watercraft S and the obstacle) being a predetermined time or less, and the like are included. In the predetermined condition, a condition of a logical product or a logical sum of (i) to (iii) may be included.

Furthermore, in the predetermined condition, a first predetermined condition and a second predetermined condition that is more unlikely to be satisfied than the first predetermined condition may be included. In such a case, for example, the predetermined distance of (i) or (ii) is set to 3 [m] in the first predetermined condition, and the predetermined distance of (i) or (ii) is set to 1 [m] in the second predetermined condition. Similarly, for example, the predetermined time of (iii) is set to 10 [seconds] in the first predetermined condition, and the predetermined time of (iii) is set to 5 [seconds] in the second predetermined condition. These numerical values are merely examples and can be arbitrarily changed.

In other words, the judgment unit 120 identifies a position of an obstacle from a top view using the second machine learning model, furthermore calculates a relative distance, a reference distance, a collision prediction time, or the like as a positional relation between the obstacle and the watercraft S, and judges whether or not these calculated indexes satisfy the conditions of (i) to (iii).

Furthermore, in a case in which the predetermined condition is further divided into a first predetermined condition and a second predetermined condition, the judgment unit 120 judges whether or not indexes such as a relative distance, a reference distance, and a collision prediction time satisfy each of the first predetermined condition and the second predetermined condition.

The judgment unit 120, for example, performs the judgment described above for each of areas acquired by dividing a top view into four parts including front, rear, left, and right divisions. The divided areas, for example, may be divided into eight parts including front, rear, left, right, and diagonal divisions. Areas for which the first predetermined condition and the second predetermined condition are judged may be areas divided into different number of parts.

The description of the flowchart will be continued. Next, the display control unit 130 causes the first display 20-1 to display an oblique view and/or a top view in which various image objects are superimposed or causes the second display 20-2 to display an image object superimposed onto each view (Step S106). A type of image object superimposed onto each view is different in accordance with necessity or non-necessary of satisfaction of a predetermined condition. In accordance with this, the process of this flowchart ends.

### Screen Example of Display

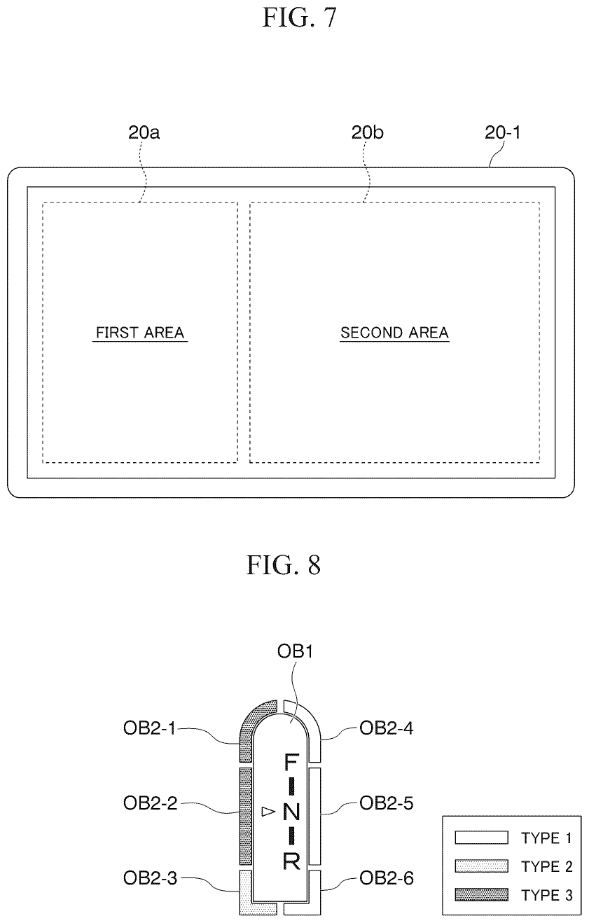

Hereinafter, a screen example of the first display 20-1 and the second display 20-2 according to this embodiment will be described. FIG. 7 is a diagram illustrating one example of a screen of the first display 20-1 according to an embodiment. As illustrated in the drawing, the screen of the first display 20-1 is divided into a first area 20a and a second area 20b. For example, one of an oblique view and a top view is displayed in the first area 20a, and the other thereof is displayed in the second area 20b. In addition, on the entire screen of the first display 20-1 in which the first area 20a and the second area 20b are aligned, a top view is displayed, or an oblique view is displayed.

For example, when the top view is displayed on the first display 20-1 as a process of S106 described above, the display control unit 130 superimposes a ship object OB1 and a virtual line object OB2 on the top view.

The ship object OB1 is an image object simulating a watercraft S. The virtual line object OB2 is one or a plurality of line-shaped image objects disposed in the vicinity of the ship object OB1 and is an image object representing a positional relation between the watercraft S and an obstacle.

In addition, the display control unit 130 may superimpose the ship object OB1 and the virtual line object OB2 also on the oblique view in addition to the top view. An image object may be rephrased with an indicator.

FIG. 8 is a diagram illustrating one example of the ship object OB1 and the virtual line object OB2. For example, a plurality of virtual line objects OB2-1 to OB2-6 may be displayed on an outer edge of the ship object OB1. The ship object OB1 may be an image of a watercraft S that has been actually imaged by the camera 10 or may be an icon, an animation, a symbol, or the like prepared in advance. Furthermore, a shift position of the watercraft S may be displayed on the ship object OB1. At least a front shift (F in the drawing), a neutral shift (N in the drawing), and a rear shift (R in the drawing) may be included in the shift position.

The display control unit 130 has the type (aspect) at the time of displaying the virtual line object OB2 to be different between a case in which a positional relation (a relative distance, a collision prediction time, or the like) between the watercraft S and an obstacle satisfies a predetermined condition and a case in which the positional relation does not satisfy the predetermined condition.

First, the display control unit 130 causes virtual line objects OB2-1 to OB2-6 of Type 1 to be displayed on an outer edge of the ship object OB1. Type 1 is a default type. A color of the virtual line object OB2 of Type 1, for example, is configured to be white that is inconspicuous, and a line of the virtual line object OB2, for example, is configured to have a standard thickness.

When the virtual line object OB2 of the default Type 1 is displayed, for example, for each of areas acquired by dividing a top view into four parts including front, rear, left, and right parts, success/no-success of a predetermined condition is assumed to be judged. In such a case, the display control unit 130 determines a type of the virtual line object OB2 corresponding to each area. For example, in a case in which an obstacle approaches from a left side when seen in an advancement direction of the watercraft S, in the area of the left side of the watercraft S, (i) the relative distance between the watercraft S and an obstacle becomes a predetermined distance or less or (iii) the collision prediction time between the watercraft S and the obstacle becomes a predetermined time or less.

The display control unit 130 changes types of the virtual line objects OB2-1, OB2-2, and OB2-3 disposed in an area of the left side of a watercraft S that an obstacle approaches, that is, on the left side of the ship object OB1 to Type 2 or 3 and, on the other hand, maintains the types of the virtual line objects OB2-4, OB2-5, and OB2-6 disposed in a an area of the left side of the watercraft S that the obstacle approaches, that is, on the right side of the ship object OB1 to be Type 1.

Type 2 is a type for more highlighted display of the virtual line object OB2 than that of Type 1. The color of the virtual line object OB2 of Type 2, for example, becomes yellow that is more conspicuous than white, and the line of the virtual line object OB2, for example, becomes thicker than that of Type 1.

Type 3 is a type for more highlighted display of the virtual line object OB2 than that of Type 2. The color of the virtual line object OB2 of Type 3, for example, becomes red that is more conspicuous than yellow, and the line of the virtual line object OB2, for example, becomes thicker than that of Type 2.

For example, in a case in which a positional relation (a relative distance, a collision prediction time, or the like) between a watercraft S and an obstacle does not satisfy any one of the first predetermined condition and the second predetermined condition, the display control unit 130 causes the virtual line object OB2 of default Type 1 to be displayed. More specifically, in a case in which the predetermined distance of (i) is set to 3 [m] as the first predetermined condition, the predetermined distance of (i) is set to 1 [m] as the second predetermined condition, and a relative distance between a watercraft S and an obstacle exceeds 3 [m], the display control unit 130 causes the virtual line object OB2 of default Type 1 to be displayed.

In addition, in a case in which a positional relation (a relative distance, a collision prediction time, or the like) between a watercraft S and an obstacle satisfies the first predetermined condition and does not satisfy the second predetermined condition that is more unlikely to be satisfied, the display control unit 130 causes the virtual line object OB2 of Type 2 to be displayed. More specifically, in a case in which the predetermined distances of (i) of the first predetermined condition and the second predetermined condition are set to the numerical values described above, and the relative distance between the watercraft S and the obstacle is 3 [m] or less and exceeds 1 [m], the display control unit 130 causes the virtual line object OB2 of Type 2 to be displayed.

In addition, in a case in which the positional relation (the relative distance, the collision prediction time, or the like) between the watercraft S and the obstacle satisfies both the first predetermined condition and the second predetermined condition, the display control unit 130 causes the virtual line object OB2 of Type 3 to be displayed. More specifically, in a case in which the predetermined distances of (i) of the first predetermined condition and the second predetermined condition are set to the numerical values described above, and the relative distance between the watercraft S and the obstacle is 1 [m] or less, the display control unit 130 causes the virtual line object OB2 of Type 3 to be displayed.

In this way, in a case in which the predetermined condition is divided into the first predetermined condition and the second predetermined condition, the display control unit 130 may determine the type of the virtual line object OB2 in accordance with satisfaction or non-satisfaction of each condition.

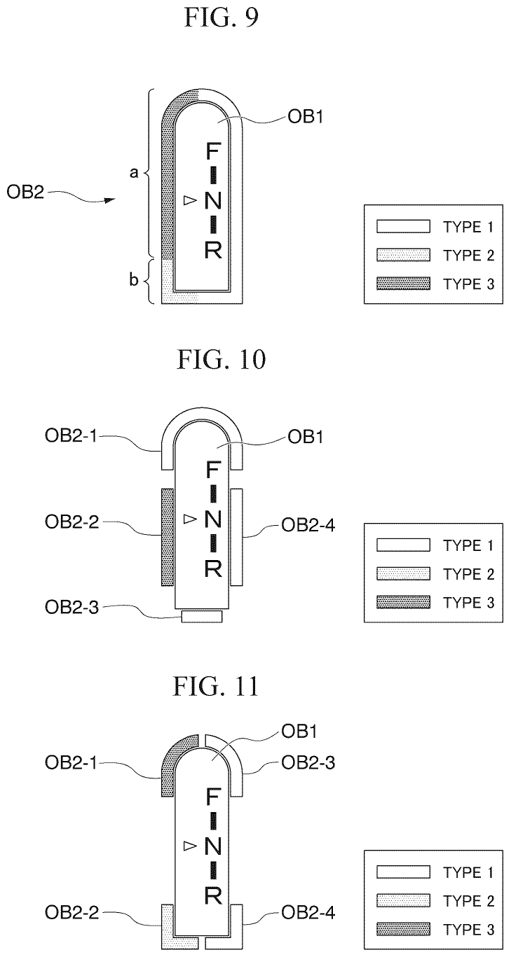

FIG. 9 is a diagram illustrating another example of the ship object OB1 and the virtual line object OB2. For example, the display control unit 130 may cause a virtual line object OB2 of one circular shape that is not partitioned at all to be displayed on an outer edge of the ship object OB1. In such a case, as in a and b illustrated in the drawing, the display control unit 130 may change the type of a partial area of the virtual line object OB2 of the circular shape.

FIGS. 10 and 11 are diagrams illustrating other examples of a ship object OB1 and virtual line objects OB2. For example, the display control unit 130 may cause virtual line objects OB2 to be displayed in four places on a front side, a rear side, a right side, and a left side of the outer edge of a ship object OB1 or may cause virtual line objects OB2 of a “U” shape to be displayed in four places on a right front side, a left front side, a right rear side, and a left rear side of an outer edge of a ship object OB1. In this way, the virtual line objects OB2 are disposed at mutually-different positions on the outer edge of the ship object OB1.

Furthermore, the display control unit 130, in addition to or in place of the ship object OB1 and the virtual line objects OB2, may cause the first display 20-1 to display other image objects. For example, the display control unit 130 may superimpose an image object representing a rudder angle of the outboard motor steering device 50 of the watercraft S (hereinafter, referred to as a rudder angle object OB4) as the other image object onto a top view. In addition, the display control unit 130 may superimpose the rudder angle object OB4 also onto an oblique view in addition to the top view.

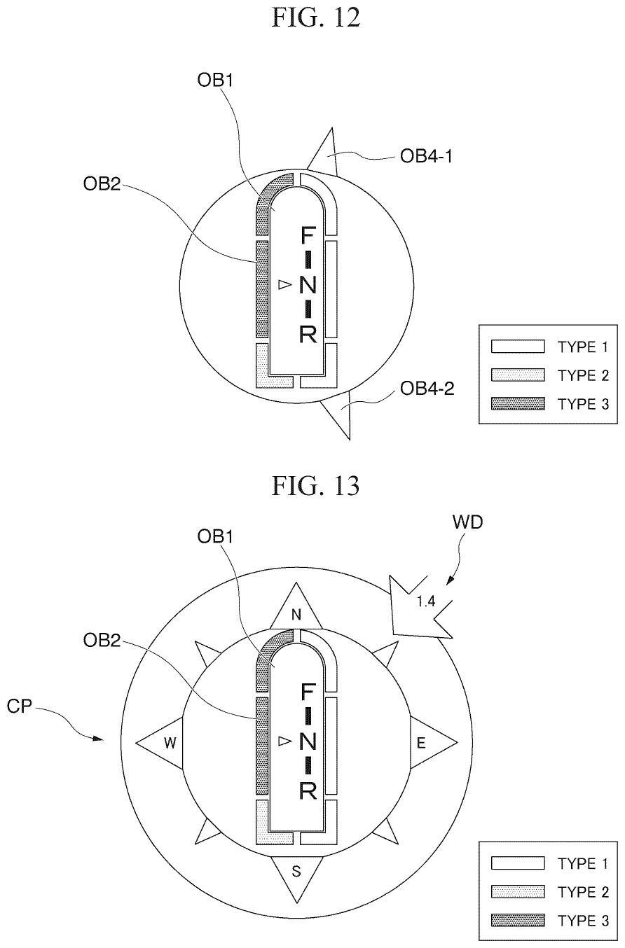

FIG. 12 is a diagram illustrating one example of the rudder angle object OB4. As illustrated in the drawing, the display control unit 130 disposes an image object with a circular shape in the vicinity of the ship object OB1 as the rudder angle object OB4 and causes a front rudder angle object OB4-1 representing a rudder angle of the front side of the outboard motor steering device 50 and a rear rudder angle object OB4-2 representing a rudder angle of the rear side of the outboard motor steering device 50 to be displayed on the circumference thereof. The circle of the rudder angle object OB4 may be either a perfect circle or an oval. In other words, the display control unit 130 causes the ship object OB1 and the virtual line object OB2 to be displayed on the inner side of the rudder angle object OB4 of the circular shape. In accordance with this, the entire objects become compact, and, even when those objects are superimposed onto a top view, a range in which a video of the top view is blocked becomes small, and thus a user's visibility can be improved.

In addition, for example, the display control unit 130 may superimpose an image object representing an azimuth measured by the azimuth sensor 30 (hereinafter, referred to as an azimuth object CP), an image object representing a wind direction and a wind speed measured by the wind direction/wind speed sensor 40 (hereinafter, referred to as a wind direction/wind speed object WD), and the like onto a top view as other image objects. Furthermore, the display control unit 130 may superimpose the azimuth object CP and the wind direction/wind speed object WD onto also an oblique view in addition to the top view.

FIG. 13 is a diagram illustrating one example of the azimuth object CP and the wind direction/wind speed object WD. As illustrated in the drawing, the display control unit 130 disposes an image object with a circular shape in the vicinity of the ship object OB1 as an azimuth object CP and further causes image objects representing azimuths such as the east, the west, the south, and the north to be displayed on the circumference thereof. In addition, the display control unit 130 causes an image object representing a wind direction and a wind speed for a watercraft S to be displayed on a further outer side of the azimuth object CP of the circular shape as a wind direction/wind speed object WD.

Furthermore, for example, the display control unit 130 may superimpose a distance marker OB3 onto an oblique view as the other image object. The distance marker OB3, similar to the virtual line object OB2, is an image object representing a positional relation between a watercraft S and an obstacle and is an image object representing a relative relation with an obstacle disposed at a position farther than the virtual line object OB2. In addition, the display control unit 130 may superimpose the distance marker OB3 also onto the top view in addition to the oblique view. The distance marker OB3, typically, may be constantly displayed. In accordance with this, an operator can easily recognize a positional relation (for example, a relative distance) with an obstacle from a scale of the distance marker OB3 and can predict when the type (a color, a thickness, or the like) of the virtual line object OB2 is changed.

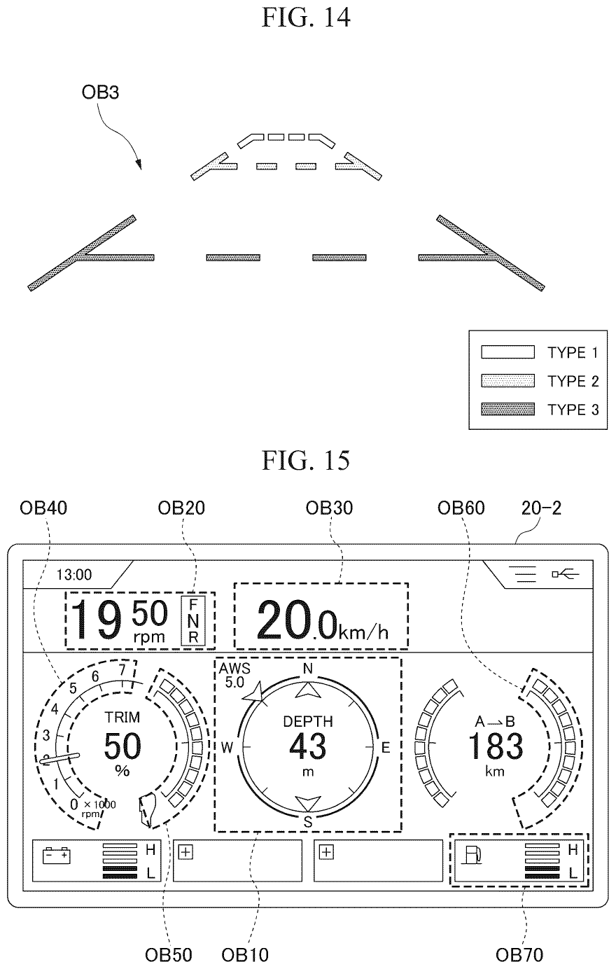

FIG. 14 is a diagram illustrating one example of the distance marker OB3. As illustrated in the drawing, in the distance marker OB3, up to a range 1 [m] away from a watercraft S is displayed in Type 3, a range from 1 [m] to 3 [m] is displayed in Type 2,and a range more than 3 [m] away therefrom is displayed in Type 1. In this way, similar to the virtual line object OB2, the type of the distance marker OB3 is determined in accordance with satisfaction/non-satisfaction of each condition.

In other words, in a case in which a positional relation (a relative distance, a collision prediction time, or the like) between a watercraft S and an obstacle satisfies a predetermined condition, the display control unit 130 causes more highlighted display of the distance marker OB3 than in a case in which the predetermined condition is not satisfied. In addition, in a case in which the positional relation between the watercraft S and the obstacle satisfies the second predetermined condition, the display control unit 130 performs more highlighted display of the distance marker OB3 than that in a case in which the positional relation between the watercraft S and the obstacle satisfies the first predetermined condition (display in Type 2 or 3). Furthermore, the distance marker OB3 may have a plurality of patterns in accordance with a water face. For example, the water face differs in a case in which the fuel is full and a case in which the fuel is not full. Similarly, the water face differs in a case in which the number of occupants is a maximum and a case in which the number of occupants is not the maximum. Thus, the display control unit 130 may have the size and the appearance of the distance marker OB3 to be different in accordance with the amount of remaining of fuel and the number of occupants (that is, in accordance with the water face).

When the first display 20-1 is caused to display the oblique view and the top view onto which various image objects are superimposed as the process of S106 described above, the display control unit 130 also causes the second display 20-2 to display various image objects superimposed onto the oblique view and the top view.

FIG. 15 is a diagram illustrating one example of a screen of the second display 20-2 according to an embodiment. As illustrated in the drawing, the display control unit 130 causes a plurality of image objects 10 to 70 to be displayed.

An image object OB10 is a complex image object in which the rudder angle object OB4, the wind direction/wind speed object WD, the azimuth object CP, and the like described above are aligned.

An image object OB20 is an image object that represents a rotation number of an engine of the drive device 60 using a real number. An image object OB30 is an image object representing the speed of the watercraft S. An image object OB40 is an image object that represents the rotation number of the engine in units of meters. One memory, for example, corresponds to 1,000 rotations. An image object OB50 is an image object that represents a trim angle of the watercraft S in units of meters. An image object OB60 is an image object that represents a remaining amount of fuel consumed by the drive device 60 in units of meters. An image object OB70 is an image object that represents an amount of consumption of fuel according to the drive device 60 in units of meters.

The image object OB40 and the image object OB50 are disposed forming parts of mutual circles to be approximately concentric. One end sides are notched to an empty space such that scales thereof are not connected to each other, and, at the other ends, icons informing display details of the objects may be displayed.

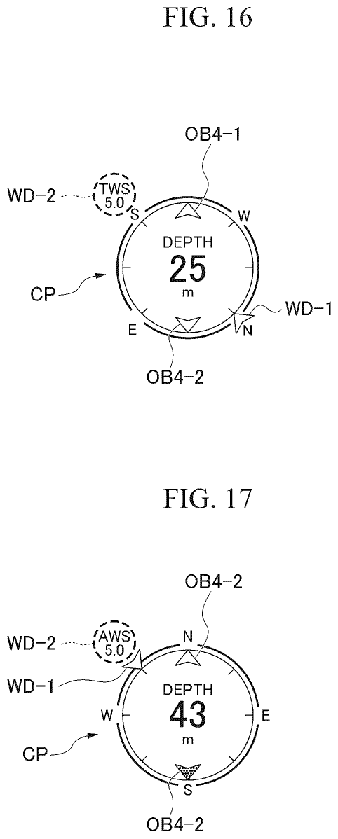

FIG. 16 is a diagram illustrating one example of the image object OB10 at the time of having a tail wind. In a case in which a watercraft S cruises in a tail wind, the display control unit 130 causes the second display 20-2 to display a complex image object in which a front rudder angle object OB4-1 representing a front rudder angle of the outboard motor steering device 50, a rear rudder angle object OB4-2 representing a rear rudder angle of the outboard motor steering device 50, and an image object representing a wind direction (hereinafter, referred to as a wind direction object WD-1) measured by the wind direction/wind speed sensor 40 are disposed on concentric circles as the image object OB10.

For example, the front rudder angle object OB4-1 and the rear rudder angle object OB4-2 may be disposed on the inside of a concentric circle, and the wind direction object WD-1 may be disposed on the outside of a concentric circle.

Furthermore, in a case in which the circumference of the concentric circle is divided into two arcs, the front rudder angle object OB4-1 may be disposed in one divisional arc, and the rear rudder angle object OB4-2 may be disposed on the other arc division.

These front rudder angle object OB4-1 and the rear rudder angle object OB4-2 may be displayed to be emphasized such as turning on light, changing of the color to red of which visibility is improved with respect to black that is a background color of the display, enlarging of an arrow, or the like in accordance with a shift position of the watercraft S. For example, in a case in which the shift position of the watercraft S is a front shift (in the case of F in the drawing), the front rudder angle object OB4-1 is displayed to be more emphasized than the rear rudder angle object OB4-2. To the contrary, in a case in which the shift position of the watercraft S is a rear shift (in the case of R in the drawing), the rear rudder angle object OB4-2 is displayed to be more emphasized than the front rudder angle object OB4-1.

In the concentric circle of the image object OB10, an azimuth object CP may be further disposed. On the outside of this concentric circle, an image object representing a wind speed measured by the wind direction/wind speed sensor 40 (hereinafter, referred to as a wind speed object WD-2) is disposed.

On the inside of the concentric circle, other information relating to sailing of the watercraft S (hereinafter, referred to as sailing information) may be displayed. In this sailing information, for example, a target speed of the watercraft S, a water depth, and the like may be included. In addition, in addition to this, a rotation number of an engine, a speed of the watercraft S, a trim angle, an amount of remaining fuel, an amount of consumption of fuel, and the like displayed as the image objects 20 to 70 may be included in the sailing information.

FIG. 17 is a diagram illustrating one example of the image object OB10 at the time of being against the wind. In a case in which a watercraft S cruises against the wind, similar to that at the time of having a tail wind, the display control unit 130 causes the second display 20-2 to display a complex image object in which a front rudder angle object OB4-1, a rear rudder angle object OB4-2, and a wind direction object WD-1 are disposed on concentric circles as the image object OB10.

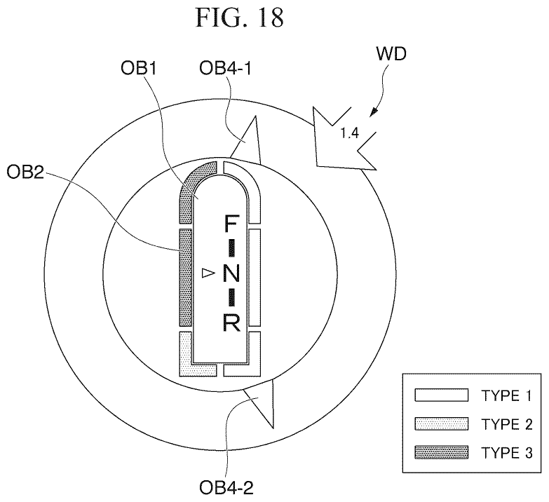

FIG. 18 is a diagram illustrating another example of the screen of the second display 20-2 according to the embodiment. As illustrated in the drawing, the display control unit 130 disposes an image object with a circular shape in the vicinity of a ship object OB1 as a rudder angle object OB4 and causes the second display 20-2 to further display a front rudder angle object OB4-1 and a rear rudder angle object OB4-2 on the circumference thereof. Furthermore, the display control unit 130 may cause the second display 20-2 to display an image object representing a wind direction and a wind speed for the watercraft S as a wind direction/wind speed object WD on the outside of the ship object OB1 of the circular shape. In this way, various image objects displayed in the first display 20-1 may be displayed also in the second display 20-2.

According to the embodiment described above, the operation support system 1 causes the second display 20-2 to display a complex image object in which a front rudder angle object OB4-1 representing a front rudder angle of the outboard motor steering device 50, a rear rudder angle object OB4-2 representing a rear rudder angle of the outboard motor steering device 50, and a wind direction object WD-1 representing a wind direction measured by the wind direction/wind speed sensor 40 are disposed on concentric circles as the image object OB10.

In this way, since a rudder angle and a wind direction of the watercraft S are caused to be displayed in the second display 20-2, an operator can intuitively recognize effects of the rudder angle and the wind direction on the behavior of the watercraft S. As a result, anybody can easily operate the watercraft S.

In addition, in the embodiment described above, although a top view has been described to be generated from an oblique view, the configuration is not limited thereto. For example, by causing a flying object (for example, a drone or the like) in which a camera is mounted to fly above the watercraft S, the watercraft S may be imaged from the flying object. The processing device 100 of the operation support system 1 may acquire an image captured from above using the flying object as a top view.

The embodiment described above can be expressed as below.

### Supplementary Note 1

An operation support system including: a display mounted in a watercraft; a storage medium storing computer-readable instructions; and a processor connected to the storage medium, the processor executing the computer-readable instructions to cause the display to display objects in which a rudder angle representing a rudder angle of a propeller of the watercraft and a wind direction representing a wind direction in the vicinity of the watercraft are disposed on concentric circles.

### Supplementary Note 2

An operation support method using an operation support system causing a display mounted in a waterborne moving system to display objects in which a rudder angle representing a rudder angle of a propeller of the watercraft and a wind direction representing a wind direction in the vicinity of the watercraft are disposed on concentric circles.

While forms for performing the present invention have been described with reference to the embodiment, the present invention is not limited to such an embodiment at all, and various modifications and substitutions can be applied within a range not departing from the concept of the present invention.

What is claimed is:

1. An operation support system comprising:
a display mounted in a watercraft; and
a display control unit causing the display to display objects in which a rudder angle representing a rudder angle of a propeller of the watercraft and a wind direction representing a wind direction in the vicinity of the watercraft are disposed on concentric circles.

2. The operation support system according to claim 1, wherein the display control unit causes the display to display the object in which the rudder angle is disposed on any one of the inside and the outside of the concentric circles, and the wind direction is disposed on the other of the inside and the outside of the concentric circles.

3. The operation support system according to claim 2, wherein the display control unit causes the display to display the object in which the rudder angle is disposed on the inside of the concentric circle, and the wind direction is disposed on the outside of the concentric circle.

4. The operation support system according to claim 1, wherein a forward rudder angle representing the rudder angle at the time of the watercraft going forward and a backward rudder angle representing the rudder angle at the time of the watercraft going backward are included in the rudder angle, and wherein, in a case in which a circumference of the concentric circle is divided into two arcs, the display control unit causes the display to display the object in which the forward rudder angle is disposed in one arc division, and the backward rudder angle is disposed in the other arc division.

5. The operation support system according to claim 4, wherein the display control unit displays any one of the forward rudder angle and the backward rudder angle to be emphasized in accordance with a shift position of the watercraft.

6. The operation support system according to claim 1, wherein the display control unit further displays an azimuth on the concentric circle of the object.

7. The operation support system according to claim 1, wherein the display control unit further displays sailing information that is other information relating to sailing of the watercraft in the display.
